(19) United States
(12) Patent Application Publication
(10) Pub. No.: US 2023/0034769 A1
(43) Pub. Date: Feb. 2, 2023

(54) Method for an Intelligent Alarm Management in Industrial Processes

(71) Applicant: ABB Schweiz AG, Baden (CH)

(72) Inventors: Moncef Chioua, Montreal (CA); Marcel Dix, Mannheim (DE); Benjamin Kloepper, Mannheim (DE); Ioannis Lymperopoulos, Dietikon (CH); Dennis Janka, Heidelberg (DE); Pablo Rodriguez, Ilvesheim (DE)

(73) Assignee: ABB Schweiz AG, Baden (CH)

(21) Appl. No.: 17/966,012

(22) Filed: Oct. 14, 2022

Related U.S. Application Data
(63) Continuation of application No. PCT/EP2021/059529, filed on Apr. 13, 2021.

(51) Int. Cl. G05B 13/02; G05B 23/02

(52) U.S. Cl. CPC G05B 13/027; G05B 23/0254; G05B 2223/02

(57) ABSTRACT

A method and computer program product including training a machine learning model by means of input data and score data, wherein the machine learning model is an artificial neural net, ANN; running the trained machine learning model by applying the first time-series to the trained machine learning model; and outputting, by the trained machine learning model, an output value, comprising at least a second criticality value of the at least one predicted observable process-value indicative of the abnormal behaviour of the industrial process in a predefined temporal distance.

### CROSS-REFERENCE TO RELATED APPLICATIONS

This patent application claims priority to International Patent Application No. PCT/EP2021/059529, filed on Apr. 13, 2021, which claims priority to International Patent Application No. PCT/EP2020/060755, filed on Apr. 16, 2020, each of which is incorporated herein in its entirety by reference.

### FIELD OF THE DISCLOSURE

The present disclosure relates to the field of intelligent alarm management, particularly in industrial processes.

### BACKGROUND OF THE INVENTION

At least some industrial processes, e.g., in a plant, may be of such a complexity that its behavior is not always clear to operators and/or service personnel. Particularly the recognition of abnormal behavior may be difficult and/or error-prone for at least some situations. This may become even more complicated, because sometimes too many alarms may be raised to get a clear understanding of the current criticality of the industrial processes.

### BRIEF SUMMARY OF THE INVENTION

In a general aspect, the present disclosure describes an improved alarm management for industrial processes. One aspect of the disclosure relates to a method for finding an abnormal behavior of an industrial process. The method comprises the steps of:
training a machine learning model by means of input data and score data, wherein the machine learning model is an artificial neural net, ANN,
wherein the input data comprise a first time-series of at least one observable process-value of the industrial process, a second time-series of at least one manipulated variable that influences the industrial process, and a third time-series of at least one internal variable of the industrial process;
and wherein the score data comprise a first criticality value of each of the at least one observable process-value indicative of the abnormal behavior of the industrial process, and a fourth time-series of at least one predicted observable process-value of the industrial process;
running the trained machine learning model by applying the first time-series to the trained machine learning model; and
outputting, by the trained machine learning model, an output value, comprising at least a second criticality value of the at least one predicted observable process-value indicative of the abnormal behavior of the industrial process in a predefined temporal distance.

### BRIEF DESCRIPTION OF THE SEVERAL VIEWS OF THE DRAWING(S

FIG. 1 is a schematic diagram of a cooperation of an industrial process with a machine learning model according to an embodiment of the present disclosure.

FIG. 2 is a schematic diagram of a look-up table comprising input data and criticality values according to an embodiment of the present disclosure.

FIG. 3 is a block diagram of certain elements and input data according to an embodiment of the present disclosure.

FIG. 4 is a flowchart of a training process according to an embodiment of the present disclosure.

FIG. 5 is a flowchart for a prediction process according to an embodiment of the present disclosure.

FIG. 6 is a block diagram of a surrogate model training workflow according to an embodiment of the present disclosure.

FIG. 7 is a block diagram of an exemplary process for using a surrogate model for predictive alarms according to an embodiment of the present disclosure.

FIG. 8 is a chart showing zones of the alarm management system corresponding to the time evolution of a process variable according to an embodiment of the present disclosure.

FIG. 9 is a schematic showing zones or alarm limits according to another embodiment of the present disclosure.

FIG. 10 is a block diagram of a training process of a machine learning model according to an embodiment of the present disclosure.

FIG. 11 is a block diagram of an operation stage of an alarm management system according to an embodiment of the present disclosure.

FIG. 12 is a chart showing example situations in which a prediction-based alarm according to an embodiment of the present disclosure is beneficial.

FIG. 13 is a block diagram of a surrogate model training workflow according to an embodiment of the present disclosure.

FIG. 14 is a functional diagram of a surrogate model for predictive alarms according to an embodiment of the present disclosure.

FIG. 15 is a flowchart for a method using online simulation according to an embodiment of the present disclosure.

FIG. 16 is a functional diagram of an example of a root-cause analysis with data from simulation and machine learning according to an embodiment of the present disclosure.

FIG. 17 is a flowchart for a method according to an embodiment of the present disclosure.

### DETAILED DESCRIPTION OF THE INVENTION

FIG. 1 schematically shows a cooperation of an industrial process 50 with a machine learning model 10 according to an embodiment. The industrial process 50 can be watched or observed by a first time-series 21 of observable process-values PV. The industrial process 50 further has a third time-series 23 of at least one internal variable IV, which may be non-observable, i.e. not directly observable and/or “observable” by means of a simulation or the like. The industrial process 50 is controlled and/or steered by a second time-series 22 of at least one manipulated variable MV. The MV may be entered into the system by an operator, service personnel, and/or one or more automated processes. The machine learning model 10 may be an artificial neural net, ANN. The machine learning model 10 has input data 20, which comprise the first time-series 21, the third time-series 23, and the second time-series 22. The third time-series 23 of IVs may be displayed in an IV table 68.

The machine learning model 10 further has score data 30, which comprise a first criticality value 32 and a fourth time-series 34. The first criticality value 32 may be based on and/or may be a function of a current observable process-value PV and/or on a first time-series 21 of observable process-values PV, thus considering a longer time-span of PVs. Said function may be built by a mapping device 62. The mapping device 62 may further output the first criticality value 32 to an alarm display 64. There may be one or more alarm displays 64 in the system. The alarm display(s) 64 may further be fed by another components and/or modules of the system, e.g. by sensor-outputs, like temperature, pressure, and many more, dependent on the industrial process 50. The fourth time-series 34 comprises at least one predicted observable process-value PPV of the industrial process 50. The prediction of the predicted observable process-value PPV may be based on historical data. The machine learning model 10 outputs an output value 40. The output value 40 comprising a second criticality value 42 and a fifth time-series 44. The fifth time-series 44 may be similar to the fourth time-series 34, and/or simply “feed forward” the fourth time-series 34, thus making simulation results available as an integral part of the model’s data. The second criticality value 42 is a function of the at least one predicted observable process-value PPV. Hence, the second criticality value 42 is a kind of “condensed knowledge” of the process behavior, possibly including aspects of future development of PVs.

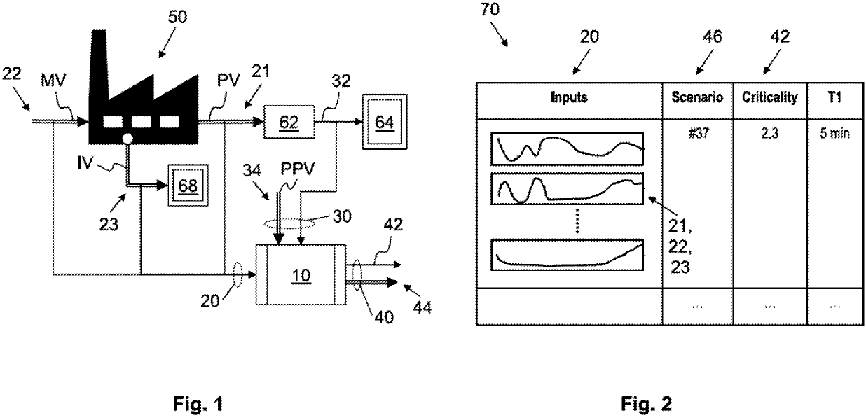

FIG. 2 schematically shows an example look-up table 70, comprising input data 20 and a second criticality value 42 according to an embodiment. The input data 20 may comprise a plurality of time-series 31, 22, 23 of a plurality of PVs, MVs, and IVs. The score data 30 may comprise a first criticality value and/or further values. The look-up table 70 may further comprise a scenario number 46 of the industrial process 50, thus indicating a “state” the industrial process 50 is currently in. The example look-up table 70 may further comprise a predefined temporal distance T1, which may, for instance, indicate the basis of the second criticality value 42, i.e. a predicted value in temporal distance T1.

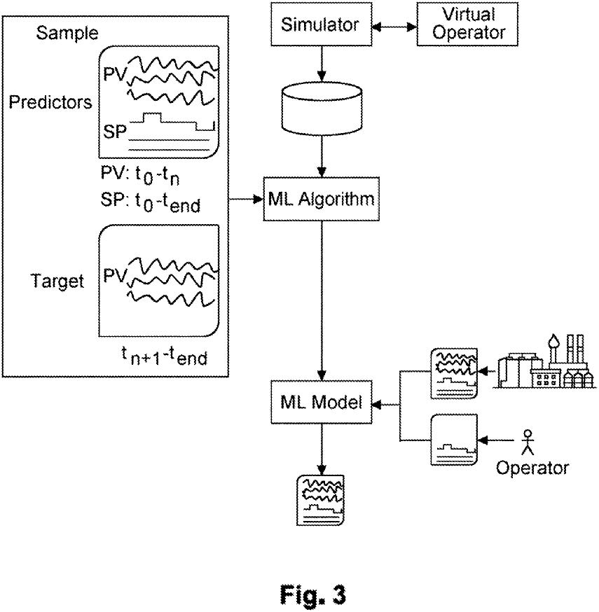

FIG. 3 schematically shows some elements, input data, and their interactions according to an embodiment. shows the solution elements and their interactions. The simulator may comprise a model of both the industrial process and equipment, and of the control system. The virtual operator is a software module that may apply predefined or preprogrammed operator actions (e.g. setpoint or MV changes) to the simulated control system. The data exchange may be done by an appropriate API (Application Programming Interface), OPC DA (Application Programming Interface Data Access), or via scripted user actions, e.g. executing cursor movement and keyboard inputs. The virtual operator performs certain operator actions during a simulation run of the first-principles-model (e.g. simulating an internal behavior) starting from a given initial state. The data produced by the first-principles-model of the process plant is stored in a database and is used for machine learning by the ANN or machine learning model. Alternatively, the ANN may be trained using the data stream from the simulator without storing the data.

The ANN (sometimes called “ML learning algorithm” or “ML algorithm”) is trained using data samples of process values (PVs) over a time window ranging from time t₀ to tₙ, of control loop setpoints, manipulated variable (MVs), or operator actions over the same time window t₀ to tₙ and planned future setpoint from tₙto t_{end}. The target (the process variables to be predicted) are the process values from tₙ₊₁ until t_{end}. During operation, the trained ML model will be fed with data similar to the predictor: process values and setpoints from t₀ until tₙand the planned future trajectory of setpoints from the operator from tₙ₊₁ until t_{end}. The model may output the expected plant behavior in terms of future process variable trajectories.

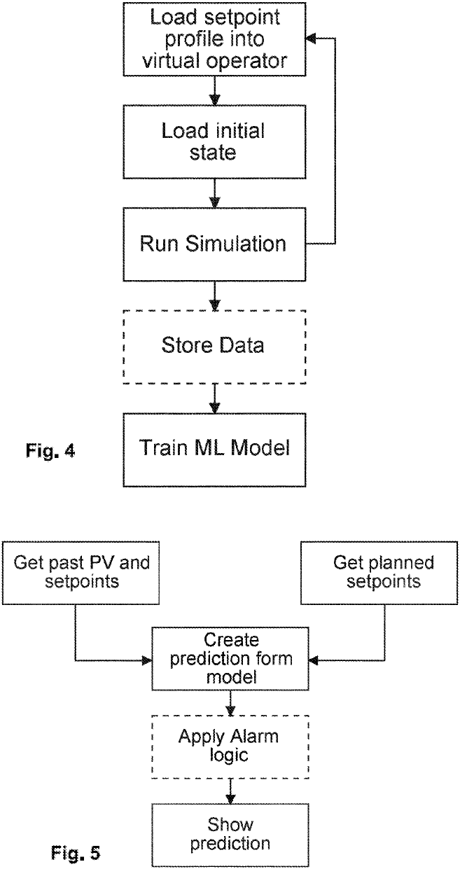

FIG. 4 schematically shows a training process according to an embodiment. This may be a subsequent activity w.r.t. FIG. 3. Initially, the virtual operator loads a setpoint profile. Then, the initial state of the simulation is loaded and the simulation is run. During the simulation run, the virtual operator manipulates the setpoints. Optionally, the data is stored, possibly for other usage, and the machine learning model is trained and saved.

FIG. 5 schematically shows a prediction process, typically run during run time of the industrial process, according to an embodiment. Past process values and setpoints are collected from the plant automation system including the process plant historian. The operator provides the planned setpoint trajectories; this may comprise, in the simplest case, just one setpoint. The trained model performs a prediction over a specified time horizon. Optionally, a predictive alarm logic is used to indicate to the operator if alarms will be triggered by the predicted process value trajectories. Finally, the process values trajectories and the corresponding alarms are shown to the operator.

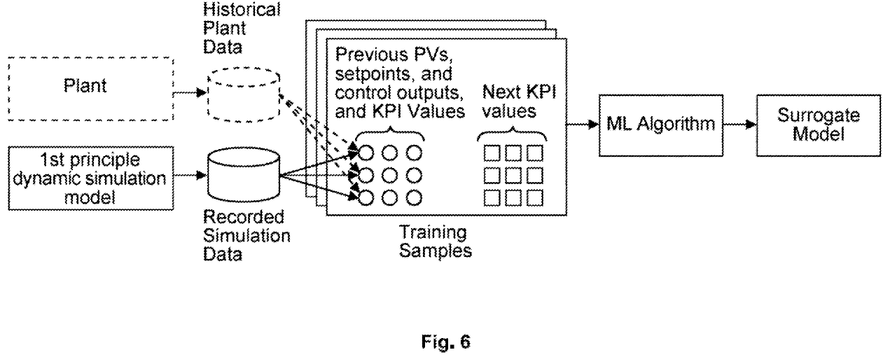

FIG. 6 schematically shows a surrogate model training workflow according to an embodiment. A first-principle dynamic plant model is used to create the data that is recorded to serve as training data. A simulation may be a feasible method, because during regular production the operator will avoid reaching the critical threshold, and thus the training data will be insufficient. However, in simulation such training data can be generated without negative side effects during production. Furthermore, the training data may be enriched with historical plant data. From the recorded simulation data, and optionally from historical plant data, training samples are generated. A training sample consist of process values, setpoints and control outputs, and KPI values over n points in time as the predictor variables and the next m values of one or more KPIs as the dependent variable. A common configuration will be to use several PVs, setpoints and control outputs, and KPIs and m next values of a single KPI. Here, m must be selected large enough such that the predictions include relevant time horizons.

The trainings samples are used to train a machine learning algorithm, for instance a recurrent neural network or ANN. The trained algorithms, for instance the recurrent neural networks with trained weights, will be the surrogate model or parts of it.

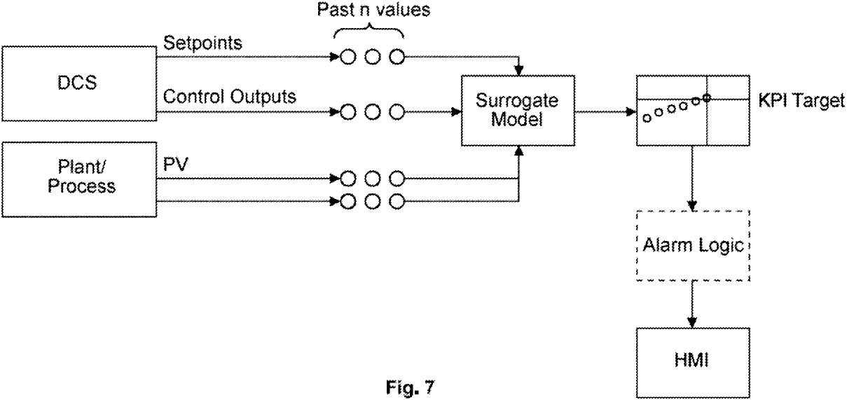

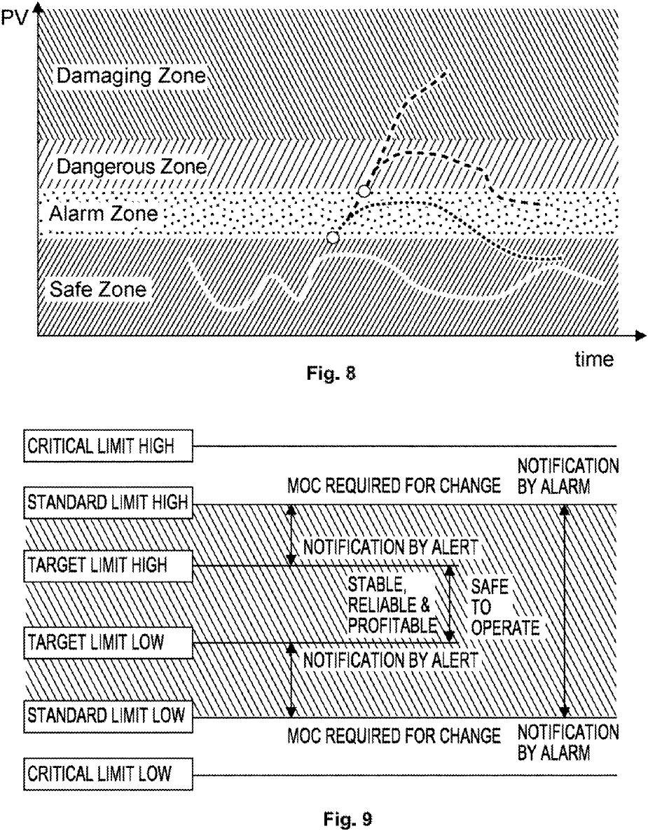

FIG. 7 schematically shows an example of using a surrogate model for predictive alarms according to an embodiment. The surrogate model is fed with the past n values of the same setpoints, control outputs, e.g. from a DCS (Distributed Control System) and process values and KPI (Key Performance Indicator) values used during training and produces a trajectory of m steps. The KPI values may come from the process, and/or from the DCS. Optionally, the trajectory of m steps is analyzed by an alarm logic, checking if the relevant target value is violated and if that is the case, an alarm will be presented on a corresponding human machine interfaces, e.g. in an alarm list. Alternatively, the future trajectory of the KPI can be presented to the operator.

FIG. 8 schematically shows zones of the alarm management system corresponding to the time evolution of a process variable according to an embodiment. An ANN system, which is sometimes called an Alarm Intelligent Deferment (AID), may actively manage incidents before they lead to alarms is proposed. AID may reduce the number of alarms issued to the PO while controlling the timing for the alarms reaching the PO. The objective of AID is to alleviate the mental load of operators and reduce human errors. A PV is commonly operating inside a safe zone as shown in FIG. 8. An AMS (Alarm Management System) may maintain a multi-zonal alarm system to avoid reaching hazardous conditions of operations. If a process variable exits the safe zone an Alarm is triggered (a visual or acoustic warning) to the operator who must manually intervene by manipulation of setpoints. If the process enters the dangerous zone, hard-coded instrumented safety systems, e.g. relief valves, etc., are triggered. It the PV cannot be controlled by those means, it enters the damaging zone where a total system shutdown can occur that can result to severe economic costs and safety hazards. The purpose of AID is to keep PVs inside the safe-zone to the maximum extent and allow only for a limited number of incidents to reach the Plant Operators (PO). The human operators can then apply their empirical knowledge at comfort without multiple alarms flooding their cognitive state. This way very few incidents, if any at all, will escape the alarm zone towards more dangerous regimes. AID will keep growing its knowledge base as it monitors the actions of the PO, e.g., resolving unseen cases, and running more simulations to expand its understanding of alarming incidents.

FIG. 9 schematically shows zones or alarm limits according to another embodiment. The zones comprise typical thresholds in the alarm management between a critical high limit and critical low limit. The alarm thresholds may be backwards defined from the critical high limit giving the operator enough time to react. The definition of the thresholds may become difficult task, particularly the operator shall be given sufficient time to react. In addition, a statically defined threshold is not capable to reflect the current state of the plant and the current dynamics. If the time required for response is defined, a prediction model may be used to decide if a process value will cross any threshold within a time window that gives enough time to the operator to react to the alarm. If the prediction model is a dynamic model of the plant, the alarm will also be able to account for the current state and dynamics of the plants.

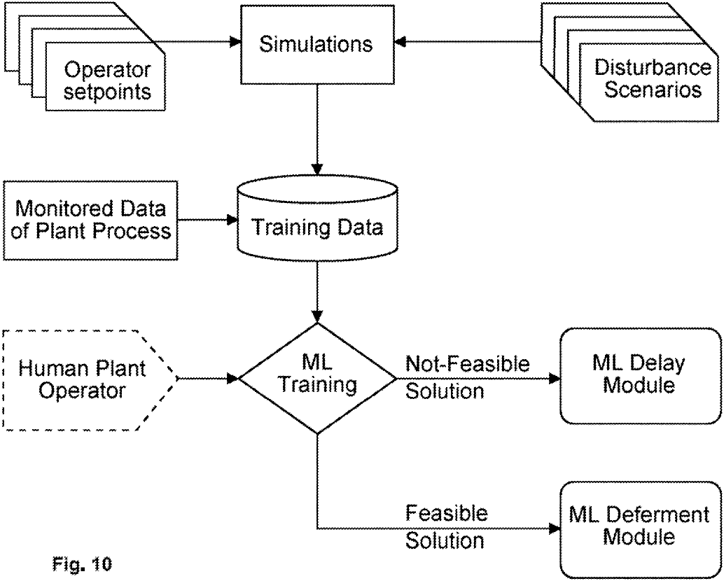

FIG. 10 schematically shows a training process of a machine learning model according to an embodiment. The training stage may be initiated offline and/or before using the machine learning model. Training data may be generated by means of multiple sources. A first source may comprise a simulation of incidents and operator actions with the corresponding results of these actions. A second source may comprise monitored data from the real process. A similar data-format is collected, more specifically: “setpoints” plus “past PV time-series” and corresponding “future PV time-series”. A time-series is defined as the evolution of a PV by time-step {PV_{t-τ}, PV_{t-τ+1}, ..., PVₜ}, while a set-point constitutes a manipulated variable accessible by the PO, {MV_{t+T}}. The combination of the PV with the MV give rise to the evolution of the PV {PVₜ₊₁, PVₜ₊₂, ..., PV_{t+T}} for a fmv (T) ahead.

The training data are collected in a knowledge-base and are used by a ML-Training system that trains two ML modules: (1) An ML Deferment module: If there exists a combination of setpoints (MV) that leads to a feasible solution of the problem for the specified time-head then the corresponding data are used to train this module. The module outputs a setpoint action for a given time-series that retains the future evolution of the PV in the safe-zone. The setpoint actions are ranked according to their KPIs from most effective to least effective. (2) An ML Delay module: If there exists no combination of setpoints in the knowledge data-based that provides a feasible solution (remain in the safe zone) for the specified time-ahead then the corresponding data are used to train this module. Different setpoint actions are ranked according to the time-delay they can append to the PV before exiting the safe-zone (compared to no-action). There may not exist any setpoint action that can add a delay to the PV in the current knowledge base.

The Human Plant Operator can be employed to guide the ML training and facilitate its effort. The main input of the PO consists in specifying which is the most-suitable MV for each incident or PV. Moreover, the PO can suggest an approximate setpoint-action, e.g. quantify the MV, according to empirical knowledge to assist even further the ML training. The ML training module prompts the PO with a query in a graphical user interface to facilitate the interaction. The query is prompted during low or zero cognitive burden of the operator. This way the ML-training system can significantly limit its exploration space and attain good initial conditions for the training of the ML modules.

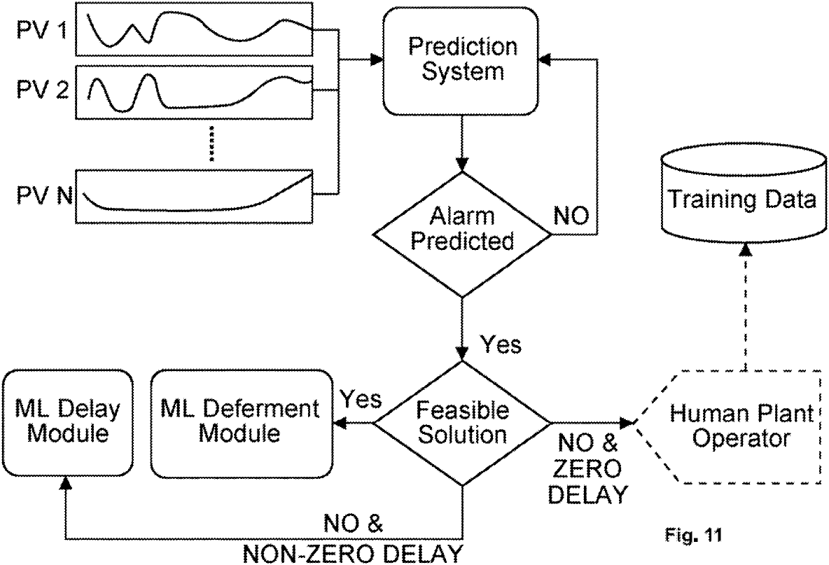

FIG. 11 schematically shows an operation stage of alarm management system according to an embodiment. The PV(s) of interest may be constantly monitored. This data is fed to the prediction system. The prediction system evaluates the probability of any of the PV in exiting the safe-zone and issuing an alarm within a predefined time-frame. If the probability is above a threshold the ML modules are called to resolve the upcoming incident.

If a feasible solution exists for this incident the ML Deferment module is called which initiates all the corresponding actions to retain the PV inside the safe-zone. If the actions undertaken are successful, the prediction system stops issuing alarm predictions.

If a feasible solution does not exist in the Knowledge base of the ML Deferment module that can resolve successfully the predicted incident, the ML Delay module is called. The ML Delay module attempts to insert a time-buffer before the actual alarm is issued. If the PO is under a heavy cognitive load (the PO is already processing multiple issued alarms on other incidents) the ML Delay module selects the maximum feasible delay. If the PO is under low or zero cognitive load the module selects a small or zero delay accordingly.

If no feasible solution exists and no-delay can be added to the evolution of predicted alarm the PO is notified appropriately. The actions of the PO to resolve the alarm are recorded and augment the knowledge base accordingly, so that the incident will be resolved autonomously in a future occurrence augmenting the problem solving capacity of the AID.

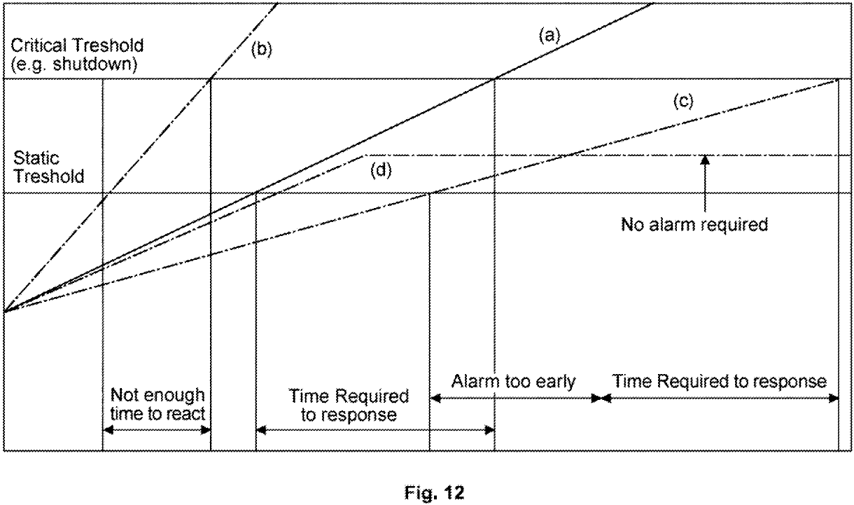

FIG. 12 schematically shows examples situations where a prediction-based alarm according to an embodiment is beneficial. It shows four different process value trajectories:
(a) The assumed PV trajectory that is used to define a static threshold. The threshold is chosen in such a way, that the operator has just enough time to respond to the alarm and prevent the PV to cross the critical threshold.
(b) A case where the PV increases faster than assumed. The alarm will be activated too late and the operator has not enough time to respond.
(c) The opposite of (b), the PV increases more slowly than assumed. The alarm is activated too early. According to alarm management standards, this is also not desirable. The operator may ignore the alarm
(d) The trajectory changes after crossing the static threshold and will never cross the critical threshold. The alarm is not required.

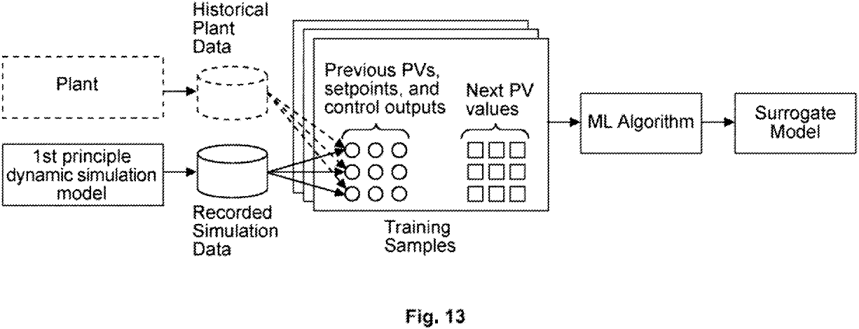

FIG. 13 schematically shows a surrogate model training workflow according to an embodiment. A first-principle dynamic plant model is used to create the data that is recorded to serve as training data. A simulation is used because during production the operator will avoid reaching the critical threshold and the training data will be insufficient. However, in simulation such training data can be generated without negative side effects during production. However, the training data may be enriched with historical plant data. From the recorded simulation data, and optionally historical plant data, training samples are generated. A training sample consist of process values, setpoints and control outputs over n points in time as the predictor variables and the next m values of one or more process values as the dependent variable. A common configuration will be to use several PVs, setpoints and control outputs and n next values of a single PV. Here, m must be selected large enough such that the predictions include relevant time horizons, i.e., longer than the time to react. The trainings samples are used to train a machine learning algorithm, for instance a recurrent neural network. The trained algorithms, for instance the recurrent neural networks with trained weights, will be the surrogate model.

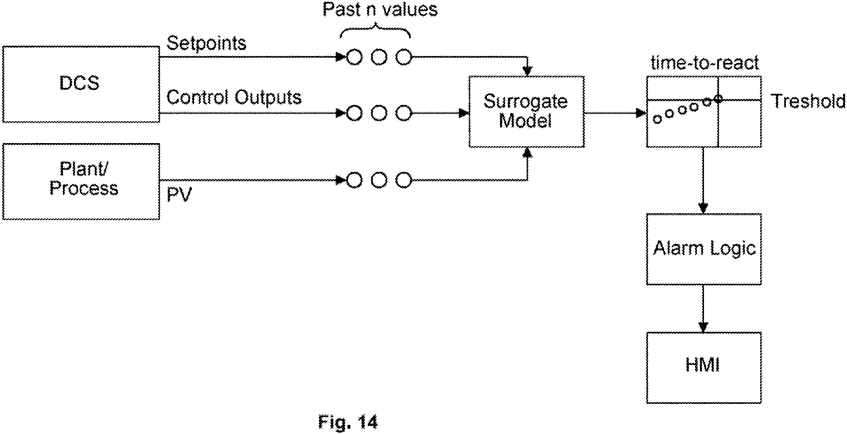

FIG. 14 schematically shows an example using a surrogate model for predictive alarms according to an embodiment. The surrogate model is fed with the past n values of the same setpoints, control outputs, e.g. from DCS, and process values, e.g. from process, technically maybe as well from DCS, used during training and produces a trajectory of m steps. The number of m steps corresponds to the time required to respond to an alarm. The trajectory of m steps is analyzed by an alarm logic, checking if the relevant threshold value is violated and if that is the case, the alarm will be presented on a corresponding human machine interfaces, e.g. an alarm list.

In a variant, the alarm logic may still evaluate based on a static threshold but analyses if (a) there is still sufficient time to respond if the alarm is issued at the static threshold, (b) there is more time than required to respond, or (c) the PV may not reach the critical threshold. In case of (a), the logic may activate the alarm earlier than usual and provide the HMI with information why, e.g. projected trajectory. In case of (b), the logic may not suppress the alarm, but add additional information on the HMI that there is still time to respond, e.g. projected trajectory. In case of (c), the logic may not suppress the alarm, but add additional information on the HMI that there may be no need to react at all, e.g. projected trajectory.

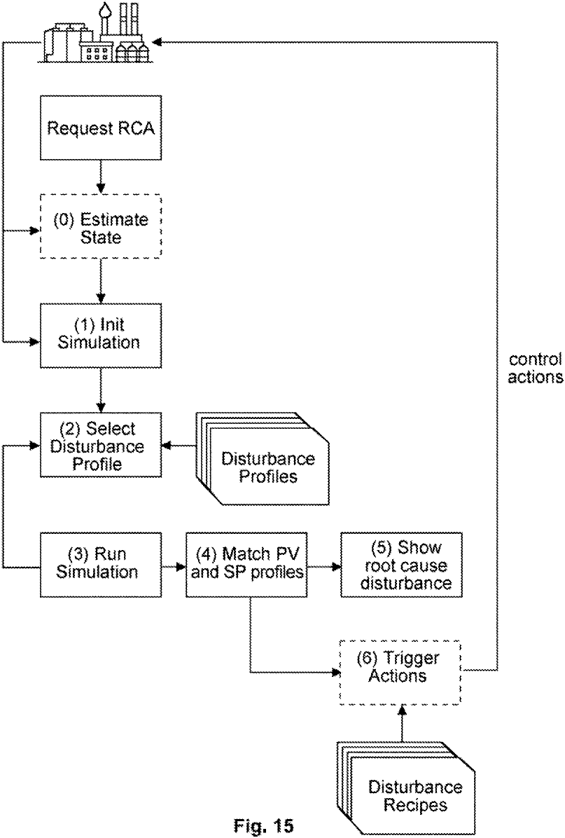

FIG. 15 schematically shows a method using online simulation according to an embodiment. For this, current plant data is feed into the system. (0) In a first step, the state of plant may be estimated and the estimated state is used to (1) initialize the simulation or the simulation initialized by feeding plant data into the simulation until the simulation converges with a real plant state. This real plant state may be in the past, ideally when the disturbance appeared or even earlier. Next, (3) a disturbance profile is selected. The selection can be based on the readings from the plant, e.g. by ruling out certain disturbances as unlikely. It is also possible that several disturbance profiles are selected for the same simulation run. (4) with the disturbance profile the simulation is run. Steps (3) and (4) may happen in a concurrent execution. The data, i.e. process values PV and setpoints SP (or MV) produced by the simulation will be matched against the actual plant data. The matching may happen with a suitable distance measure like Euclidian Distance, Dynamic Timewarping (DTW), Jaccarq, Levenshtein, Correlation based, Auto-Correlation, etc. If the matching show is small enough distance, the possible root-cause is (5) presented to the user. Alternatively, the disturbance profile with the smallest measure will be presented. If for certain type of disturbances counteractions are known (recipes), either by definition from experts or from machine learning, the system can (6) recommend these measure to the user or directly trigger the execution of the actions. The simulation model may not be a first-principle model but a surrogate model to meet the real-time requirements of using the simulation online.

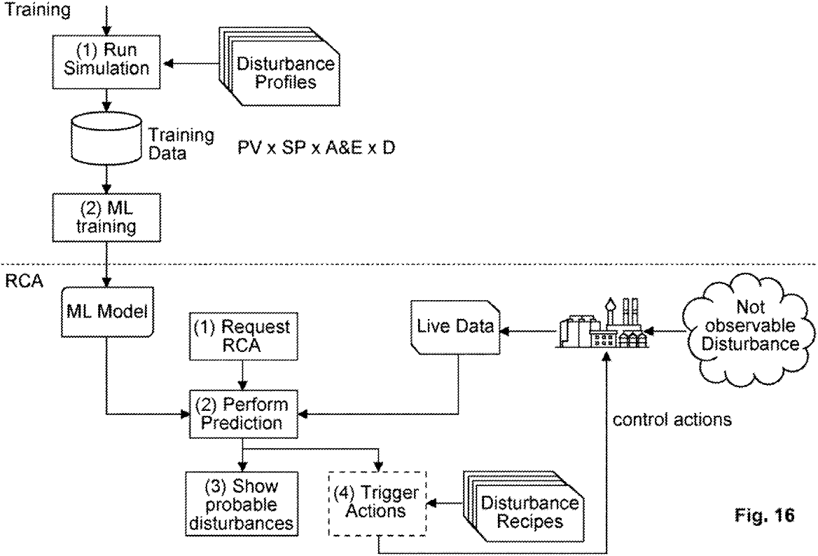

FIG. 16 schematically shows an example of a root-cause analysis with data from simulation and machine learning according to an embodiment. A variant may not use a simulation and/or a surrogate model and disturbances directly. Instead, a machine learning model may be trained to identify possible root-cause disturbances. The process is split into two steps: Training and Root Cause Analysis (RCA).

In Training, the simulation is executed with a large number of disturbance profiles and combination of disturbance profiles. The simulation produces training data with predictor - e.g., process values, setpoints, alarms and events - and the disturbance profiles used during the simulation, either as continuous signal or just as disturbance identifier. In a second step, a Machine Learning classifier is trained using the disturbance information as label or a machine learning regression is trained to reproduce the disturbance profile. The created model is then used for the RCA task.

During RCA, the RCA is request either by the operator or monitoring system, e.g. an anomaly detection system. The data collected from the plant is fed into the machine learning model. The output may then be presented as probable root causes to the operator. If for certain type of disturbances counteractions are known (recipes), either by definition from experts or from machine learning, the system can (4) recommend these measure to the user or directly trigger the execution of the actions.

A variant may comprise to try the actions from the disturbance recipes first on the surrogate models and evaluated. The course of actions - e.g. timing, sequence, values of setpoints, etc. - may be varied in an optimization loop, e.g. using Bayesian Optimization, and may optimize the action based on an objective time, e.g. minimize time-of-execution, maximize throughput during execution, etc.

A variant may be implemented in deployments that run a Digital-Twin of the plant processes. The digital-twin is digitally replicating the plant-process using model-based dynamics. However, those are just an approximation of the real-process and they slowly deviate from what happens in the plant. The standard practice is to synchronize the digital-twin to the physical plant-process using measurements from the latter. However, these measurements are not always sufficient to distinguish between different internal states that may be producing the exact same measurements. This may have a different impact in the future evolution of the plant. The digital-twin may not run one instant that conforms with the state of the real-plant, but multiple possible scenarios, weighted according to some probability. Keeping, discarding or reweighting these scenarios can happen using the ML Model. Whenever a signature of a disturbance is detected, some of the instances that are running in parallel are discarded or re-weighted. Additionally, if no internal state exists that conforms with the ML Model, the ML may need to augment its training data-based using the relevant scenario from the digital-twin.

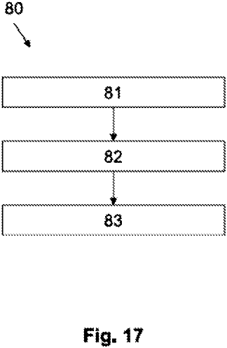

FIG. 17 schematically shows a flowchart 80 of a method according to an embodiment.

In a step 81, a machine learning model 10 (see FIG. 1) is trained by means of input data 20 and score data 30. The machine learning model 10 - also called ML model - is an artificial neural net, ANN. The input data 20 comprise a first time-series 21 of at least one observable process-value PV of the industrial process 50, a second time-series 22 of at least one manipulated variable MV that influences the industrial process 50, and a third time-series 23 of at least one internal variable IV of the industrial process 50. The score data 30 comprise a first criticality value 32 of each of the at least one observable process-value PV indicative of the abnormal behavior of the industrial process 50, and a fourth time-series 34 of at least one predicted observable process-value PPV of the industrial process 50. In a step 82, the trained machine learning model 10 is run by applying the first time-series 21 to the trained machine learning model 10. In a step 83, the trained machine learning model 10 outputs an output value 40, comprising at least a second criticality value 42 of the at least one predicted observable process-value PPV indicative of the abnormal behavior of the industrial process 50 in a predefined temporal distance T1.

The industrial process may be run in an industrial plant, as used, e.g., in chemical and process engineering. The industrial process may be configured for producing and/or for manufacturing substances, for instance materials and/or compounds. The abnormal behavior may be a behavior that deviates from an intentional behavior of the industrial process and/or of the industrial plant. The abnormal behavior may be indicated by an observable (“external”) value - such as temperature or pressure in a vessel of the plant - and/or may be indicated by a non-observable (“internal”) value, for instance an internal non-intentional disturbance of mixed compounds. The abnormal behavior may lead to an alarm, either in short-term, e.g. immediately, and/or in some temporal distance, e.g. in a couple of seconds, minutes, and/or other time-spans.

The machine learning model is an artificial neural net, ANN, which is used after a training and/or a training phase. The training may be done once or may be repeated during the model’s use. The training may be done by means of input data and score data; however, further data may also be used for the training. The time-series of the input data and/or of the score data may be based on data recordings of the past. Due to this, a “future behavior” of the industrial process may be “known”, i.e. may be part of the time-series. For instance, a fast change of one process-value may have led to a critical situation in a couple of minutes, whereas a fast change of another process-value may have turned out to be uncritical, even if an alarm has been raised. The input data may comprise: observable process-value(s), non-observable internal variable(s), possibly from simulations and/or e.g. from non-observable disturbances, and/or manipulated variable(s), e.g. from an operator that reacts on an alarm and/or other behavior of the industrial process.

The score data may be rewards and/or punishments of the ANN. The score data may comprise: a first criticality value, which may be a function of the observable process-value(s) and/or of the internal variable(s). The function may be a complex and/or a composed function of one or more variable(s). The function may be a simple one, for instance: “if temperature is lower than 32° C., then alarm5=true”. The predicted observable process-value may be based on historical data, which may show “developing” process-values, for instance: “if temperature is higher than 76° C., then alarm8=true”, because the process-behavior became critical within 2 minutes. The temporal distance may be a fixed one, e.g. 5 minutes, it could be more than one distance, and/or a variable distance, possibly influenced by at least one of the historical time-series.

The running of the trained machine learning model may be done after the training phase. At least the first time-series is applied, during operation of the process, to the trained machine learning model; however, there may further data be applied to the model.

The outputting, by the trained machine learning model, may comprise an alarm and/or and additional alarm. The alarm may be based or may comprise the second criticality value. The model’s output may be similar or different to other alarms, e.g. by other components and/or subsystems of the industrial process. In some cases, the model’s output may lead to a re-evaluation of an alarm, e.g. may lead to an “over-weighting” of one alarm and/or may lead to an “under-weighting” of one alarm. This “correction” may contribute to a more efficient alarm management in the industrial process and/or an easing of the operator’s burden. Particularly, this may ease the recognition of an abnormal behavior of the industrial process.

In various embodiments, the output value further comprises a scenario number of the industrial process, dependent on at least one of the first time-series, the second time-series, and/or the third time-series. In cases, where nor scenario number can be found, an “undefined” scenario number may be output. The scenario number may advantageously contribute to a better understanding what is currently going on in the industrial process, thus leading to a faster reaction and/or to a further investigation of the current - and/or the related historical - circumstances.

In various embodiments, the output value further comprises a fifth time-series, dependent on at least one of the first time-series, the second time-series, and/or the third time-series. The fifth time-series may be similar to the fourth time-series of predicted observable process-value(s). The fifth time-series may comprise to “bypass” the fourth time-series, thus advantageously making use of the knowledge base provided by the plurality of historical time-series. Thus, the method may facilitate or contribute to a prediction of the plant’s behavior, based on given process past and current measurements and/or data and, when considering the manipulated variables, also on planned future operator actions. This, further, may be used to train a machine learning algorithms to create fast and accurate surrogate models for the method above to be used for online deployment.

In various embodiments, the output value further comprises the first criticality value of the at least one observable process-value, i.e. of the current value. The input may also be used as an output, e.g. simply “forwarded” and/or as a kind of “shortcut” of the first criticality value. This further improves the understanding of the current process behavior.

In various embodiments, the method further comprises the step of outputting a manipulated variable dependent on at least one of the first time-series and/or the third time-series. The implementation may comprise a “simple forwarding or bypass” of this value, i.e. of an observable and/or a non-observable value. This may advantageously to a kind of seamless integration of sensor values and simulations results. This may further contribute to an insight if a feasible solution - or “standard solution” - exists for this case. Moreover, new situations may be told to the operator, possibly as an indicator of some particular attention to this situation and/or scenario.

In various embodiments, the method further comprises the step of determining a temporal distance to a second criticality value that exceeds a predefined criticality value. This may advantageously be an answer to a question like: “When will, in this situation/scenario, happen the next alarm?” or “Will, for this situation/scenario, there be an alarm?” This may advantageously be used for being able to “shift” an alarm message to discharge the personnel in some situations. Hence, a time-buffer may be inserted for this particular alarm, possibly dependent on the rising-velocity of the criticality value, e.g. in the future. This may further improve the alarm management.

In various embodiments, the method further comprises the step of determining an increasing-velocity of the second criticality value; and outputting an alarm when the increasing-velocity exceeds a predefined criticality value. This may raise an alarm as an reaction on an acceleration of some process-values, e.g. of a heating up.

An aspect relates to a computer program product comprising instructions, which, when the program is executed by a computer and/or an artificial neural net, ANN, cause the computer and/or the ANN to carry out the method described above and/or below.

An aspect relates to a computer-readable storage medium where a computer program or a computer program product as described above is stored on.

An aspect relates to a machine learning model, particularly a trained machine learning model, configured for executing a method as described above and/or below.

An aspect relates to a use of a machine learning model for monitoring and/or controlling an industrial process.

An aspect relates to an industrial plant, comprising a computer and/or an ANN (Artificial Neural Net) on which instructions are stored, which, when the program is executed by the computer and/or by the ANN, cause the computer or the industrial plant to carry out the method as described above and/or below.

For further clarification, the invention is described by means of embodiments shown in the figures. These embodiments are to be considered as examples only, but not as limiting.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for finding an abnormal behavior of an industrial process, comprising:
training a machine learning model by utilizing input data and score data, wherein the machine learning model is an artificial neural net, ANN,
wherein the input data comprises:
a first time-series of at least one observable process-value of the industrial process,
a second time-series of at least one manipulated variable that influences the industrial process, and
a third time-series of at least one internal variable of the industrial process; and wherein the score data comprises:
a first criticality value of each of the at least one observable process-value indicative of the abnormal behavior of the industrial process, and
a fourth time-series of at least one predicted observable process-value of the industrial process;
running the trained machine learning model by applying the first time-series to the trained machine learning model; and
outputting, by the trained machine learning model, an output value, comprising at least a second criticality value of the at least one predicted observable process-value indicative of the abnormal behavior of the industrial process in a predefined temporal distance.

2. The method of claim 1, wherein the output value further comprises a scenario number of the industrial process, wherein the scenario number depends on at least one of the first time-series, the second time-series, and the third time-series.

3. The method of claim 1, wherein the output value further comprises a fifth time-series, which depends on at least one of the first time-series, the second time-series, and the third time-series.

4. The method of claim 1, wherein the output value further comprises the first criticality value of the at least one observable process-value.

5. The method of claim 1, further comprising outputting a manipulated variable dependent on at least one of the first time-series and the third time-series.

6. The method of claim 1, further comprising the step of determining a temporal distance to a second criticality value that exceeds a predefined criticality value.

7. The method of claim 1, further comprising the steps of:
determining an increasing-velocity of the second criticality value; and
outputting an alarm when the increasing-velocity exceeds a predefined criticality value.

8. A computer program product comprising instructions, which, when the program is executed by a computer and/or an artificial neural net, ANN, cause execution of the instructions that cause the following processes to be executed:
training a machine learning model by utilizing input data and score data, wherein the machine learning model is an artificial neural net, ANN,
wherein the input data comprises:
a first time-series of at least one observable process-value of the industrial process,
a second time-series of at least one manipulated variable that influences the industrial process, and
a third time-series of at least one internal variable of the industrial process; and wherein the score data comprises:
a first criticality value of each of the at least one observable process-value indicative of the abnormal behavior of the industrial process, and
a fourth time-series of at least one predicted observable process-value of the industrial process;
running the trained machine learning model by applying the first time-series to the trained machine learning model; and
outputting, by the trained machine learning model, an output value, comprising at least a second criticality value of the at least one predicted observable process-value indicative of the abnormal behavior of the industrial process in a predefined temporal distance.

9. The computer program product of claim 8, wherein the output value further comprises a scenario number of the industrial process, wherein the scenario number depends on at least one of the first time-series, the second time-series, and the third time-series.

10. The computer program product of claim 8, wherein the output value further comprises a fifth time-series, which depends on at least one of the first time-series, the second time-series, and the third time-series.

11. The computer program product of claim 8, wherein the output value further comprises the first criticality value of the at least one observable process-value.

12. The computer program product of claim 8, further comprising outputting a manipulated variable dependent on at least one of the first time-series and the third time-series.

13. The computer program product of claim 8, further comprising the step of determining a temporal distance to a second criticality value that exceeds a predefined criticality value.

14. The computer program product of claim 8, further comprising the steps of:
determining an increasing-velocity of the second criticality value; and
outputting an alarm when the increasing-velocity exceeds a predefined criticality value.
